(19) United States
(12) Patent Application Publication
(10) Pub. No.: US 2009/0079941 A1
(43) Pub. Date: Mar. 26, 2009

(54) THREE-DIMENSIONAL IMAGE PROJECTION SYSTEM AND METHOD

(75) Inventors: Joshua O. Miller, Woodinville, WA (US); Christian D. DeJong, Sammamish, WA (US)

Correspondence Address: MICROVISION, INC., 6222 185TH AVENUE NE, REDMOND, WA, 98052, US

(73) Assignee: MICROVISION, INC., Redmond, WA (US)

(21) Appl. No.: 11/858,696

(22) Filed: Sep. 20, 2007

(51) Int. Cl. G03B 21/00

(52) U.S. Cl. 353/8

(57) ABSTRACT

An image projection system having an optical projector and a method for projecting an image. The image projection system enables viewing the images in three dimensions and securely viewing the images in a public forum. The image projection system may include a portable, handheld optical projector that is spaced apart from a display screen and that redirects an image signal to the display screen. The image signal is scattered by the display screen and transmitted to a viewer's eyes through a set of eyewear worn by the viewer. The display screen preserves the polarization state of the image signal. The portable handheld optical projector may be a cellular phone, a personal digital assistant, a portable computer, or the like that includes one or more sets of light emission systems capable of projecting the image signal. The optical projector may be portable and handheld, or stationary or semi-stationary.

### TECHNICAL FIELD

The present invention relates, in general, to an imaging system and, more particularly, to an image projection system.

### BACKGROUND

Many types of imaging systems are available for displaying a still image or a series of images such as a series of video frames in two dimensions (“2D”). For example, a cathode ray tube (“CRT”) is a display device used in televisions and computer monitors. Liquid crystal displays (“LCDs”) are used in a variety of applications such as digital watches, laptop computers, cellular telephones, personal digital assistants, etc. Newer plasma displays are also used for computer monitors and televisions, and field emission displays (“FEDs”) are often used where a small display is needed. Most of these devices have maximum sizes. For example, to keep the weight and beam scanning power to practical levels, the maximum size of a CRT should be in the range of 30 to 40 inches along a diagonal of the CRT. Other constraints such as manufacturing complexities limit the sizes of other devices such as LCDs, plasma displays, and FEDs.

To overcome these drawbacks, engineers have developed image-projection systems that display larger images. For example, a projection television system generates video frames by projecting the video frames onto a display screen. However, these systems are relatively complex, expensive to manufacture and maintain, and provide low quality images. A projection television system not only includes the relatively complex electronics of a conventional CRT television set, but also includes relatively complex projection optics for projecting the video frames onto a screen. Further, the projection optics often degrade the video frames such that they have a lower quality than video frames displayed on a CRT.

In addition to displaying images in two-dimensions, projection display manufacturers have developed systems for displaying images in three-dimensions. One technique for creating three dimensional (“3D”) projection display systems is to create two separate monochromatic images. Typically one image is red and the other image is blue. Thus, the technique may be referred to as a red-blue monochromatic technique. To view the 3D image, the viewer wears goggles or glasses having right and left filters. The right filter passes the red color of the image to one eye, e.g., the right eye, and blocks the red color of the image to the other eye, e.g., the left eye, and the left filter passes the blue color of the image to the left eye and blocks the blue color of the image to the right eye. Thus, the viewer's right and left eyes see different images. These images are transmitted by the optic nerves to the brain which creates a single image having an illusion of depth. Although these systems are inexpensive to implement, the color reproduction of the images is poor and the filters may not completely block the adjacent eye's image, which causes ghosting. Further, the technique uses large immobile equipment to project the images.

Another technique for creating a 3D image is to project separate images having different polarization states. Typically, the projected image for the right eye is projected to have a polarization state that is orthogonal to the image for the left eye. The viewer wears glasses with polarization sensitive optics that transmit images to the right and left eyes that are slightly different from each other. Like the red-blue monochromatic technique, the images having different polarization states are transmitted by the optic nerves to the brain which creates a single image having an illusion of depth. This technique offers better color reproduction than the red-blue monochromatic technique, however the projection displays are large, stationary, expensive to implement, and, because about half the light is lost, inefficient.

Accordingly, it would be advantageous to have a three-dimensional display system and a method for displaying three-dimensional images that is, cost efficient to manufacture, makes efficient use of light, and may be either stationary or portable.

### BRIEF DESCRIPTION OF THE DRAWINGS

The present invention will be better understood from a reading of the following detailed description, taken in conjunction with the accompanying drawing figures, in which like reference numbers designate like elements and in which:

FIG. 1 is a perspective view of a portable three-dimensional image projection system in accordance with an embodiment of the present invention;

FIG. 2 is a block diagram of a light emission system portion of the three-dimensional image projection system of FIG. 1 in accordance with embodiments of the present invention;

FIG. 3 is a block diagram of a light emission system portion of a three-dimensional image projection system in accordance with an embodiment of the present invention;

FIG. 4 is a block diagram of a light emission system portion of a three-dimensional image projection system in accordance with another embodiment of the present invention;

FIG. 5 is a block diagram of a handheld portable optical projector in accordance with an embodiment of the present invention;

FIG. 6 is a block diagram of a handheld portable optical projector in accordance with another embodiment of the present invention;

FIG. 7 is a perspective view of the eyewear portion of the portable three-dimensional image projection system of FIGS. 1, 8, and 10 in accordance with embodiments of the present invention;

FIG. 8 is a perspective view of a portable three-dimensional image projection system in accordance with another embodiment of the present invention;

FIG. 9 is a block diagram of a light emission system portion of the three-dimensional image projection system of FIG. 8 in accordance with embodiments of the present invention;

FIG. 10 is a perspective view of a portable image projection system in accordance with another embodiment of the present invention;

FIG. 11 is a block diagram of a light emission system portion of the three-dimensional image projection system of FIG. 10 in accordance with embodiments of the present invention;

FIG. 12 is a perspective view of a portable image projection system in accordance with another embodiment of the present invention;

FIG. 13 a block diagram of a light emission system portion of the three-dimensional image projection system of FIG. 12 in accordance with embodiments of the present invention;

FIG. 14 is a perspective view of the eyewear portion of the portable three-dimensional image projection system of FIG. 12 in accordance with embodiments of the present invention; and

FIG. 15 is a perspective view of a three-dimensional image projection system in accordance with another embodiment of the present invention.

### DETAILED DESCRIPTION

Generally, the present invention provides, among other things, an image projection system that enables viewing of images in three dimensions and secure viewing of images in a public forum. In accordance with various embodiments of the present invention, three-dimensional images are created by projecting electromagnetic radiation such as, for example, light, from an optical projector onto a display screen that preserves the polarization state of light scattered by the display screen. The three-dimensional image is formed from two two-dimensional images, where one of the two images is slightly different from the other image and secure viewing is accomplished using light with different polarization states. In accordance with one embodiment, light having a first polarization state and light having a second polarization state are transmitted to a scanning device, which redirects the light to a display. The display scatters the redirected light so that the scattered light strikes eyewear worn by a viewer. The eyewear includes a polarization filter associated with the viewer's left eye and a polarization filter associated with the viewer's right eye. The polarization filters filter light depending on its polarization states. Preferably, the polarization states are set at plus and minus forty-five degrees (±45°). However, this is not a limitation of the present invention. For example, the polarization states may be set at zero and ninety degrees.

In accordance with other embodiments of the present invention, the scanning device comprises a microelectromechanical system (“MEMS”) scanner having a single mirror. Alternatively, the scanning device can be a MEMS scanner or a non-MEMS scanner that comprises a single mirror or a plurality of mirrors, i.e., there may be one, two, three, or more mirrors.

In accordance with another embodiment of the present invention, an image projection system comprises a light emission system and a scanning device, wherein the light emission system includes a plurality of light sources. For example, the light sources may be two sets of red-green-blue (“RGB”) lasers, where one set of lasers transmits light in a first polarization state and the other set of lasers transmits light in a second polarization state that is different from the first polarization state. Thus, this embodiment comprises two red lasers, two green lasers, and two blue lasers, where the red lasers emit light having different polarization states from each other, the green lasers emit light having different polarization states from each other, and the blue lasers emit light having different polarization states from each other. The light can be linearly polarized or circularly polarized. In the case of a linear polarization state, the light transmitted to one filter may be vertically polarized and the light transmitted to the other filter may be horizontally polarized. In the case of a circular polarization state, the light transmitted to one filter may be right circularly polarized and the light transmitted to the other filter may be left circularly polarized. It should be noted that the light may be coherent light or non-coherent light.

The light from one set of lasers is combined and redirected towards a display screen using a scanning device and the light from the other set of lasers is combined and redirected towards the display screen using the same scanning device as the first set of lasers or a different scanning device. The scanning device spatially modulates the light to vary the color and intensity of each pixel. The scanned beam displays are configured to slightly vary the content between the two two-dimensional images as they are projected into a viewer's eyes. The brain uses this difference in content to create an illusion of depth. More particularly, the light from one set of RGB lasers is in a first polarization state and the light from the other set of RGB lasers is in a second polarization state that is the opposite of the first polarization state. The light from all the lasers may be combined into a single light beam and spatially modulated in unison. Thus, all the light sources are scanned through the same angular extent. The three-dimensional image may be created by temporally delaying the video signal and modulating the intensity of each laser. The scattered light strikes eyewear worn by a viewer, wherein the eyewear includes a filter associated with the viewer's left eye and a filter associated with the viewer's right eye.

In accordance with another embodiment of the present invention, privacy in a public forum may be provided by the image projection system. The eyewear worn by the viewer is configured to decode polarized light. The light can be linearly polarized or circularly polarized. The portable handheld source of electromagnetic radiation projects an image in a first polarization state and an inverse image in a second polarization state that is complementary to the first polarization state. The viewer wearing the eyewear can filter one set of images seeing only the desired content transmitted by the portable handheld source of electromagnetic radiation, whereas others see a “white image” on the display screen. Thus, the viewer can view projected images that are of a personal nature or confidential while others are prevented from viewing or decoding the images. Alternatively, privacy in a public forum can be achieved by using eyewear that is synchronized to the polarization states of the light.

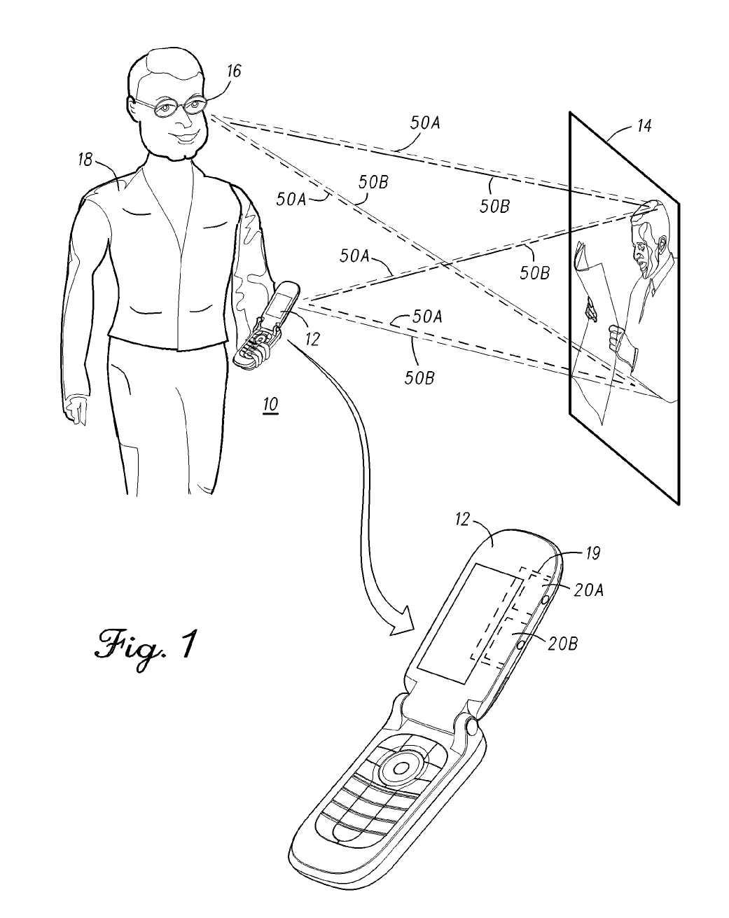

FIG. 1 is a perspective view of a portable three-dimensional image projection system 10 in accordance with an embodiment of the present invention. FIG. 1 illustrates a portable, handheld optical projector 12 that is spaced apart from and transmits light containing an image to a display screen 14. For the sake of clarity, portable handheld optical projector 12 is shown in an exploded view. Portable handheld optical projector 12 is also referred to as a mobile handheld optical projector, a portable handheld optical device, a mobile handheld optical device, or an optical device. The light is scattered by display screen 14 and transmitted to a viewer's eyes through a set of eyewear 16 worn by the viewer 18. In accordance with one embodiment, portable handheld optical projector 12 comprises a cellular phone that includes a light emission system 19 that emits light in two or more polarization states. Light emission system 19 comprises two sets of integrated photonics modules 20A and 20B that project a light or optical signal capable of producing a three-dimensional image. In other words, the image contained in the light transmitted by integrated photonics module 20A is slightly different from the image contained in the light transmitted by integrated photonics module 20B.

In other embodiments, portable handheld optical projector 12 may be a personal digital assistant (“PDA”) that includes light emission system 19 comprising integrated photonics modules 20A and 20B, a portable personal computer that includes light emission system 19 comprising integrated photonics modules 20A and 20B, a game controller that includes light emission system 19 comprising integrated photonics modules 20A and 20B, or the like. Light emission system 19 and integrated photonics modules 20A and 20B are shown by broken lines because they are within portable, handheld optical projector 12. It should be understood that the positioning of light emission system 19 within portable, handheld optical projector 12 is not a limitation of the present invention. Alternatively, light emission system 19 can be connected to portable, handheld optical projector 12 through a wireless protocol, a universal serial bus (“USB”) port, a copper cable, an optical fiber, or the like. Optical projector 12 is not limited to being portable or handheld. For example, the optical projector may be a stationary optical projector that is included in a desk top computer or it may be part of a semi-stationary optical projector, etc. A semi-stationary optical projector is one that can be moved from one location to another, but is operated while in a non-handheld stationary position, unlike a handheld portable optical projector which may be operated while being held by a viewer or other user. It should be noted that light beams 50A and 50B are described hereinbelow.

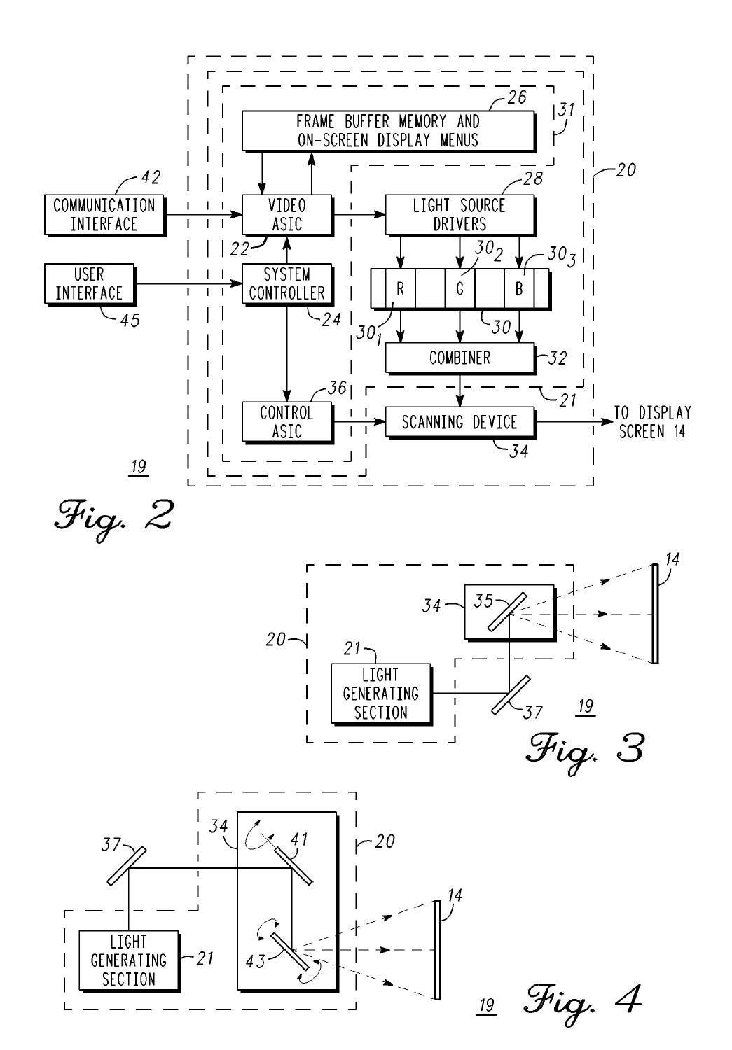

FIG. 2 is a block diagram of a light emission system 19 that includes an integrated photonics module (“IPM”) 20 suitable for use in accordance with embodiments of the present invention. Integrated photonics module 20 is also referred to as an optical element. Integrated photonics modules 20A and 20B of FIG. 1 are the same as integrated photonics module 20. However, reference characters “A” and “B” have been appended to reference character 20 of FIG. 1 to distinguish between the integrated photonics modules. Integrated photonics module 20 includes a light generating section 21 coupled to a scanning device 34. A video application specific integrated circuit (“ASIC”) 22, a system controller 24, frame buffer memory and on-screen display menus 26, light source drivers 28, a set of red, blue, and green light sources 30, a combiner 32, and a control ASIC 36 form light generating section 21 of integrated photonics module 20. Video ASIC 22, a system controller 24, frame buffer memory and on-screen display menus 26, and control ASIC 36 form a control and display element section 31 of integrated photonics module 20.

Video ASIC 22 is coupled for transmitting and receiving communications signals to and from frame buffer memory and on-screen display menus 26. Video ASIC 22 is also coupled for receiving communications signals from system controller 24 and a communications interface 42. Communications interface 42 may support wireless or hard-wired protocols such as, for example, infra-red, Bluetooth, wireless application protocols (“WAPS”), short messaging system (“SMS”), virtual private networks (“VPNS”), an Ethernet connection, an optical interconnect, a digital subscriber line (“DSL”), a USB connection, a cable modem, a metal interconnect, or the like. Video ASIC 22 is coupled for transmitting control signals to light source drivers 28, which in turn are coupled to a set of light sources 30, which is comprised of a red light source 30₁, a green light source 30₂, and a blue light source 30₃. Red light source 30₁, green light source 30₂, and blue light source 30₃ are also designated by the reference characters “R”, “G”, and “B” in FIG. 2. System controller 24 is coupled for receiving a control signal from a user interface 45.

An output terminal of video ASIC 22 is connected to frame buffer memory and on-screen display menus 26 and to light source drivers 28. The light source drivers are coupled for driving the set of red, green, and blue light sources 30₁, 30₂, and 30₃, respectively. The set of red, green, and blue light sources 30₁, 30₂, and 30₃ are also referred to as light emitting elements and may be lasers, laser diodes, or the like. Red, green, and blue light sources 30₁, 30₂, and 30₃ are coupled for transmitting light to combiner 32 which transmits a combined signal to scanning device 34. Scanning device 34 is also coupled for receiving an input signal from system controller 24 through control ASIC 36 and has an output coupled for redirecting or transmitting a light or optical signal to display screen 14.

FIG. 3 is a top view of light generating section 21 coupled to a scanning device 34 which redirects light from light emission system 19 to display screen 14. In accordance with one embodiment of the present invention, scanning device 34 comprises a MEMS bi-axial scanner 35 capable of reflecting light in horizontal and vertical directions. The light is redirected to display screen 14 which displays a two-dimensional image. The light is transmitted from light generating section 21 to an optional steering mirror 37 which reflects the light to scanning device 34. In alternate embodiments, the light from light generating section 21 may be transmitted directly to scanning device 34, i.e., optional steering mirror 37 is absent so that the light travels directly from light generating section 21 to scanning device 34. Although scanning device 34 has been described as a MEMS bi-axial scanner, this is not a limitation of the present invention. In accordance with an alternate embodiment of the present invention, scanning device 34 comprises a plurality of scanning mirrors that may be MEMS or non-MEMS scanning devices. More particularly, FIG. 4 is a top view of light generating section 21 coupled to scanning device 34 which comprises two scanning mirrors 41 and 43. The light is transmitted from light generating section 21A to an optional steering mirror 37 which reflects the light to scanning device 34. Mirror 41 redirects the light in a vertical direction towards mirror 43, which then redirects the light in a horizontal direction to display screen 14. Display screen 14 displays a two-dimensional image.

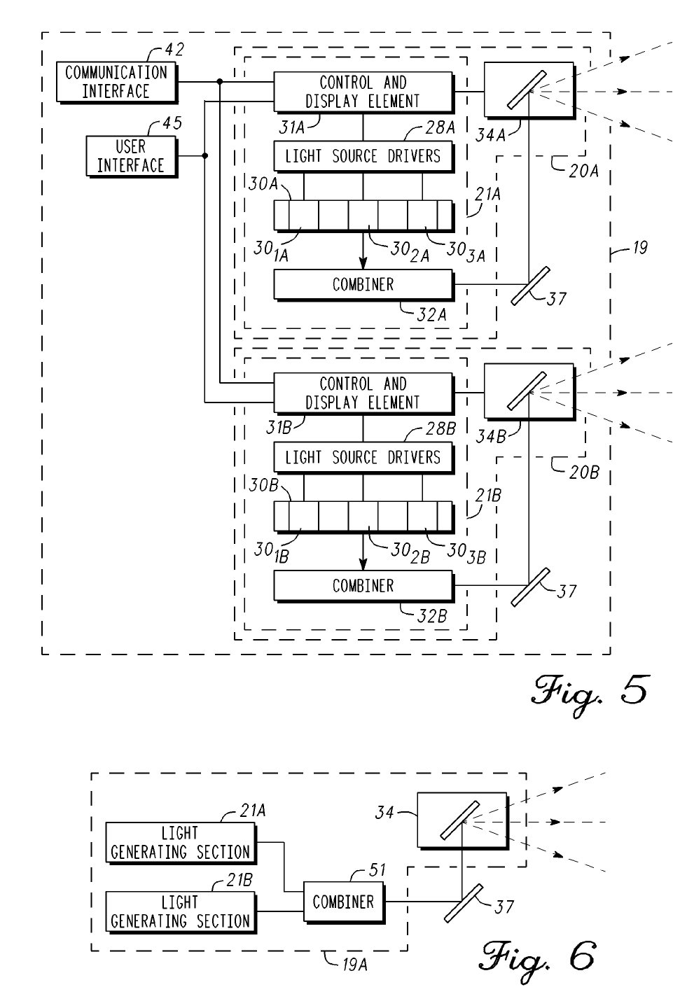

FIG. 5 illustrates a light emission system 19 that includes optical photonics modules 20A and 20B. More particularly, FIG. 5 illustrates optical photonics modules 20A and 20B that comprise a light generating section 21A coupled to a scanning device 34A and a light generating section 21B coupled to a scanning device 34B, respectively. As discussed hereinbefore, light emission system 19 comprises optical photonics modules 20A and 20B, which are coupled to scanning devices 34A and 34B, respectively. Because light emission system 19 is comprised of two scanning devices, it is referred to as a multi-scanning device scanning system. Alternatively, light emission system 19 may be comprised of a single scanning device in which case light emission system 19 is referred to as a single scanning device scanning system. An advantage of applicants' embodiments is that the same light emitting aperture can be used with a single scanning device scanning system and two apertures can be formed in close proximity to each other with a multi-scanning device scanning system. In addition, forming the light emitting apertures in close proximity precludes adjustment and alignment steps when the distance between the display screen and the light emission system.

FIG. 6 illustrates a light emission system 19A comprising a single-scanning device scanning system. What is shown in FIG. 6 is light emission system 19A which is comprised of light generating systems 21A and 21B which transmit light to a single scanning device 34 through a combiner 51 and a steering mirror 37. More particularly, light generating section 21A generates light of one or more colors in a first polarization state and light generating section 21B generates light of one or more colors in a second polarization state that is different from the first polarization state. Combiner 51 brings the light together while preserving the difference in polarization states between the light from light generating section 21A and the light from light generating section 21B. Optional fold or steering mirror 37 reflects the combined light to scanning device 34, which scans the light and produces two images. One of the images is from the light in the first polarization state that is emitted by light generating section 21A and the other image is from the light in the second polarization state that is emitted from light generating section 21B. Through the positional scanning of the light by scanning device 34 and the independent light modulation of light generating systems 21A and 21B, angularly encoded images are produced. The images can be visualized by projecting them onto a screen. These images may be substantially overlapping. Thus light emission system 19A produces two images of different polarization states from a single scanning mirror.

Referring to FIGS. 5 and 6, light generating section 21A includes control and display element 31A coupled to light source drivers 28A which are coupled for driving a red, green, and blue light source 30A, which comprises a red light source 30_{1A}, a green light source 30_{2A}, and a blue light source 30_{3A}. Light generating section 21B includes control and display element 31B coupled to light source drivers 28B which are coupled for driving a red, green, blue light source 30B, which comprises a red light source 30_{1B}, a green light source 30_{2B}, and a blue light source 30_{3B}. Thus, in accordance with this embodiment, light emission system 19 comprises six light sources. Light generating systems 21A and 21B adjust the red light transmitted by red light sources 30_{1A} and 30_{1B} to have different polarization states from each other, the green light transmitted by green light sources 30_{2A} and 30_{2B} to have different polarization states from each other, and the blue light transmitted by blue light sources 30_{3A} and 30_{3B} to have different polarization states from each. Preferably, light generating section 21A adjusts the light from light sources 30_{1A}, 30_{2A}, and 30_{3A} to have the same polarization state as each other and light generating section 21B adjusts the light from light sources 30_{1B}, 30_{2B}, and 30_{3B} to have the same polarization state as each other but which polarization state is different from the polarization state of the light from light sources 30_{1A}, 30_{2A}, and 30_{3A}. For example, light generating section 21A may adjust the light from light sources 30_{1A}, 30_{2A}, and 30_{3A} so that it is linearly polarized in a vertical polarization state whereas light generating section 21B adjusts the light from light sources 30_{1B}, 30_{2B}, and 30_{3B} so that it is linearly polarized in a horizontal polarization state. Reference characters “A” and “B” have been appended to reference characters 21, 30, 30₁, 30₂, 30₃, 31, and 34 in FIG. 5 to distinguish between light generating sections 21, red light sources 30₁, blue light sources 30₂, green light sources 30₃, and scanning devices 34.

Referring again to FIG. 1, preferably, display screen 14 is a polarization preserving screen. Thus, the light striking display screen 14 and the light scattered by display screen 14 have the same polarization state. In accordance with one embodiment, display screen 14 comprises a microlens array coated with a layer of aluminum. In accordance with another embodiment, display screen 14 comprises a surface having a silver finish. Suitable screens may be available from Da-Lite Screen Company, Warsaw, Ind., 46581-0137.

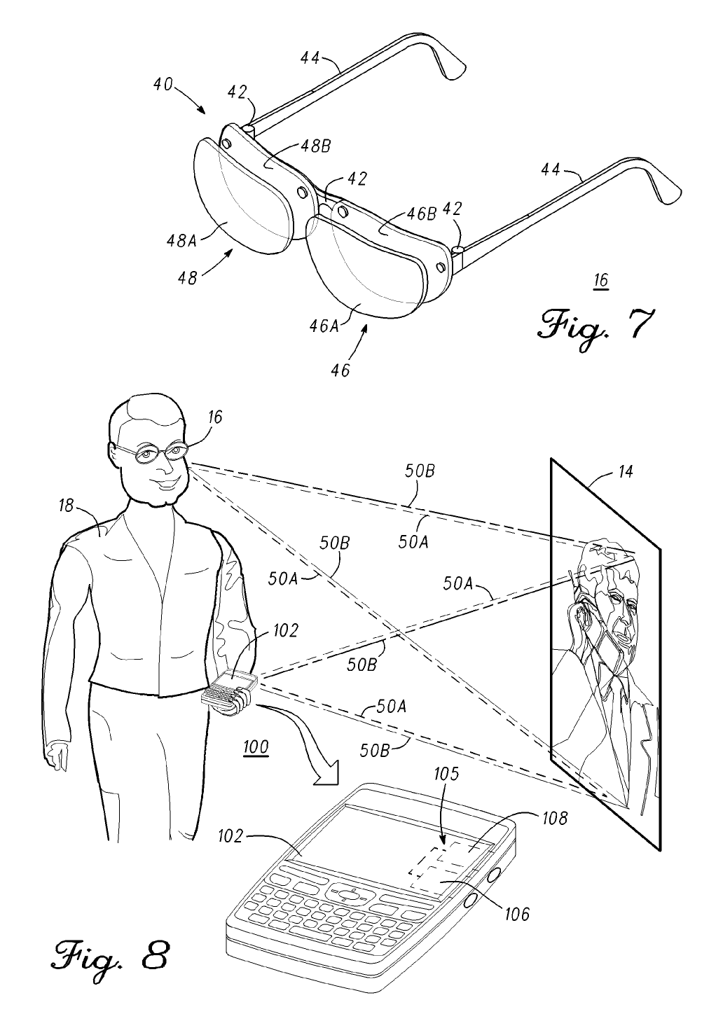

FIG. 7 is a perspective view of eyewear set 16 in accordance with an embodiment of the present invention. Eyewear set 16 comprises a frame 40 having a bow 42, temples 44, and filters 46 and 48 that transmit images to a viewer's left and right eyes, respectively. Filter 46 is configured to decode linearly polarized light having a vertical polarization state whereas filter 48 is configured to decode linearly polarized light having a horizontal polarization state. Filters 46 and 48 are illustrated in an exploded view to show that filter 46 comprises elements 46A and 48A attached to elements 46B and 48B, respectively. By way of example, filter 46 includes a quarter-wavelength plate 46A laminated to a polarizer 46B and filter 48 comprises a quarter-wavelength plate 48A laminated to a polarizer 48B. It should be noted that the type of plates laminated to polarizers 46B and 48B are not limitations of the present invention. For example, plates 46A and 48A can be waveplates, polarizer filters, combinations of polarizers, combinations of waveplates, polarizing optics, or the like. In addition, the polarization transmission characteristics of filters 46 and 48 are not limitations of the present invention. Either of filters 46 and 48 may be configured to decode vertically or horizontally polarized light or right or left circularly polarized light. Techniques for coupling plates such as plates 46A and 48A to polarizers such as polarizers 46B and 48B are known to those skilled in the art.

Alternatively, elements 46A and 48A are phase retarders and elements 46B and 48B are polarizing filters capable of passing or filtering light of two different polarization states. In yet another embodiment, eyewear set 16 can be a single layer structure, where elements 46A and 48A are absent and elements 46B and 48B are polarizing filters capable of passing or filtering light of two different polarization states.

In operation and referring to FIGS. 1-7, a user activates handheld optical projector 12 so that it projects images onto display screen 14. Activating handheld optical projector 12 enables integrated photonics modules 20A and 20B to transmit light or light signals to display screen 14. More particularly, red light source 30_{1A}, green light source 30_{2A}, and blue light source 30_{3A}, of integrated photonics module 20A emits or transmits red light, green light, and blue light in the same polarization state and red light source 30_{1B}, green light source 30_{2B}, and blue light source 30_{3B}, of integrated photonics module 20B emits or transmits red light, green light, and blue light in the same polarization state, where the polarization state of the light emitted by light sources 30_{1A}, 30_{2A}, and 30_{3A} is different from the polarization state of the light emitted by light sources 301B, 302B, and 303B. By way of example, a light ray or a light signal 50A transmitted by integrated photonics module 20A has a linear vertical polarization state and a light ray or a light signal 50B transmitted by integrated photonics module 20B has a linear horizontal polarization state. In addition, the images created by light sources 30_{1B}, 30_{2B}, and 30_{3B} are slightly different from those created by light sources 30_{1A}, 30_{2A}, and 30_{3A}. It should be noted that because handheld optical projector 12 has two integrated photonics modules, i.e., integrated photonics modules 20A and 20B, portable image projection system 10 has six light sources, e.g., six lasers, six laser diodes, six light emitting diodes, or other coherent or non-coherent light sources, or the like.

Light rays or light signals 50A and 50B strike display screen 14 and are scattered to filters 46 and 48. Filter 46 passes light rays 50A to one eye, e.g., the left eye, while blocking light rays 50B from being transmitted to the left eye. Filter 48, on the other hand, passes light rays 50B to the other eye, e.g., the right eye, while blocking light rays 50A from being transmitted to the right eye. The left and right eyes see two different images each having a different polarization state. The images are transmitted through the optic nerves to the brain, which creates a single image having an illusion of depth. An advantage of creating three-dimensional images or movies is that they enrich the viewer's experience by either mimicking the real world experience or exaggerating on it. For example, the additional depth of the three-dimensional images in medical applications improves a physician's diagnostic capabilities.

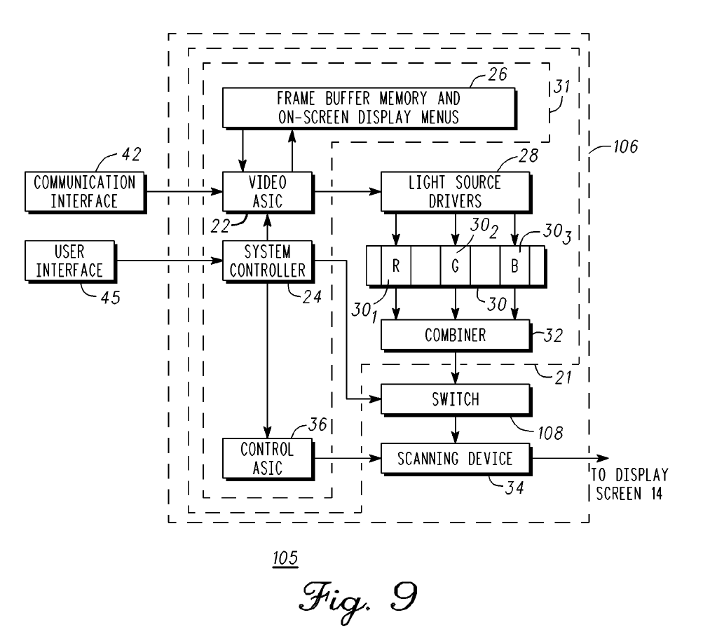

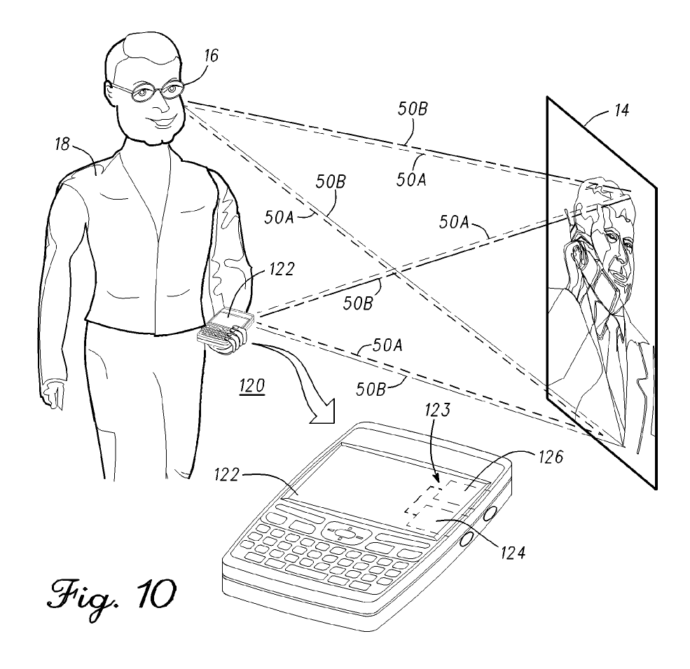

FIG. 8 is a perspective view of a portable, handheld three-dimensional image projection system 100 in accordance with another embodiment of the present invention. FIG. 8 illustrates a handheld optical projector 102 that is spaced apart from a display screen 14 and that transmits an image to display screen 14. The signal is scattered by display screen 14 and transmitted to a viewer's eyes through eyewear set 16 being worn by viewer 18. Portable handheld optical projector 102 is also referred to as a mobile optical projector a portable handheld optical device, or a mobile optical device. In accordance with one embodiment, handheld optical projector 102 comprises a personal digital assistant that includes a light emission system 105 having a single integrated photonics module 106 that transmits optical signals capable of producing a three-dimensional image.

FIG. 9 is a block diagram of a light emission system 105 that includes integrated photonics module (“IPM”) 106 suitable for use in accordance with embodiments of the present invention. Integrated photonics module 106 is also referred to as an optical element and includes a light generating section 21 coupled to a scanning device 34. Light generating section 21, control and element display section 31, and scanning device 34 have been described with reference to FIG. 2. In addition to light generating section 21, control and element display section 31, and scanning device 34, light emission system 105 includes a switch 108 coupled between combiner 32 and scanning device 34. Switch 108 switches the polarization state of each laser 30₁, 30₂, and 30₃ using an interlaced technique so that each frame is in a different polarization state from an adjacent frame. Switch 106 may be an electro-optical crystal switch, a liquid crystal switch, a mechanical wheel with polarization retarders, combinations thereof, or the like. System controller 24 transmits a control signal to switch 108 to set the switch state of switch 108. For example, system controller 24 transmits a first control signal to configure switch 108 to transmit light of one polarization state and a second control signal to configure switch 108 to transmit light of a different polarization state.

In operation and referring to FIGS. 8 and 9, user 18 activates handheld optical projector 102 so that it projects images on display screen 14. Activating handheld optical projector 102 enables integrated photonics module 106 to transmit light to display screen 14. For example, when switch 108 is in one position, integrated photonics module 106 transmits a light ray 50A containing an image that has a linear vertical polarization state and when switch 108 is in an alternate position, photonics module 106 transmits a light ray 50B containing an image that is slightly different from the image of light ray 50A and has a linear horizontal polarization state. It should be noted that the type of polarized light is not a limitation of the present invention. Another suitable polarization state may be a circular polarization state, e.g., right circularly polarized light and left circularly polarized light. Light rays 50A and 50B strike display screen 14 and are scattered to filters 46 and 48. Filter 46 passes light rays 50A transmitted to one eye, e.g., the left eye, and blocks light rays 50B from being transmitted to the left eye. Filter 48, on the other hand, passes light rays 50B transmitted to the other eye, e.g., the right eye, and blocks light rays 50A from being transmitted to the right eye. Thus, the left and right eyes see different images having different polarization states. The images are transmitted through the optic nerves to the brain, which creates a single image having an illusion of depth.

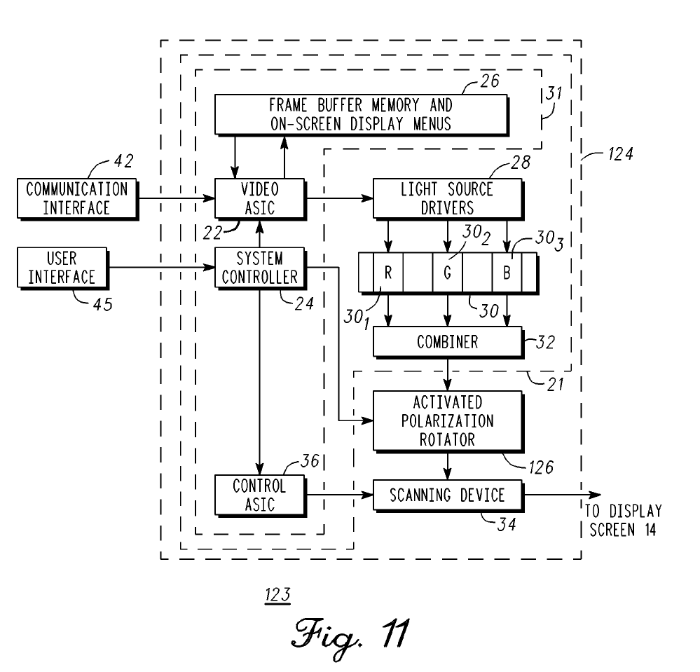

FIG. 10 is a perspective view of a portable, handheld three-dimensional image projection system 120 in accordance with another embodiment of the present invention. FIG. 10 illustrates a handheld optical projector 122 that is spaced apart from a display screen 14 and that transmits an image to display screen 14. The signal is scattered by display screen 14 and transmitted to a viewer's eyes through eyewear set 16 being worn by viewer 18. Portable handheld optical projector 122 is also referred to as a mobile optical projector, a portable handheld optical device, or a mobile optical projector. In accordance with one embodiment, handheld optical projector 122 comprises a personal digital assistant that includes a light emission system 123 having an activated polarization rotator 126 and a single integrated photonics module 124 that transmits optical signals capable of producing a three-dimensional image. Portable handheld optical projector 122 is not limited to being a personal digital assistant.

FIG. 11 is a block diagram that includes a light emission system 123 that emits light in two or more polarization states. Light emission system 123 comprises an integrated photonics module 124 that projects a light or optical signal capable of producing a three-dimensional image in accordance with embodiments of the present invention. Integrated photonics module 124 is also referred to as an optical element and includes a light generating section 21 coupled to a scanning device 34 through an activated polarization rotator 126. Thus, activated polarization rotator 126 is coupled between combiner 32 and scanning device 34. Activated polarization rotator 126 can be comprised of semiconductor doped glass, liquid crystal, Faraday rotators, Pockels Cells, or the like. Light generating section 21 and scanning device 34 have been described with reference to FIG. 2. Activated polarization rotator 126 changes the polarization states of the light transmitted by each light source 30₁, 30₂, and 30, using an interlaced technique so that each frame is in a different polarization state from an adjacent frame. Thus, the light in one frame has a first polarization state and the light in an adjacent frame has a different polarization state such that the polarization states of every other frame are the same. System controller 24 transmits a control signal to activated polarization rotator 126 to rotate the polarization states of the light transmitted by light sources 30₁, 30₂, and 30₃. For example, system controller 24 transmits a first control signal to configure activated polarization rotator 126 to transmit light of one polarization state that contains an image and a second control signal to configure activated polarization rotator 126 to transmit light of a different polarization state that also contains an image. The image contained in the light transmitted by light sources 30₁, 30₂, and 30, when activated polarization rotator 126 is in a first configuration is slightly different from the image contained in the light transmitted by light sources 30₁, 30₂, and 30, when activated polarization rotator 126 is in a second configuration. The configuration of activated polarization rotator 126 enables transmission of light from light sources 30₁, 30₂, and 30, in accordance with its polarization state.

In operation and referring to FIGS. 10 and 11, user 18 activates handheld optical projector 122 so that it projects images onto display screen 14. Activating handheld optical projector 122 enables integrated photonics module 124 to transmit light to display screen 14. System controller 24 transmits a control signal to place polarization rotator 126 in a first orientation and integrated photonics module 124 transmits a light ray 50A containing an image in a first polarization state. When system controller 24 transmits a control signal placing polarization rotator 126 in a second orientation, which rotates the polarization state of light ray 50A to have polarization state 50B. Photonics module 124 transmits light ray 50B containing an image that is slightly different from the image of light ray 50A and in a second polarization state. By way of example, the first polarization state is a linear vertical polarization state and the second polarization state is a linear horizontal polarization state. It should be noted that the type of polarized light is not a limitation of the present invention. For example, the first polarization state may be a linear horizontal polarization state and the second polarization state may be a linear vertical polarization state, or the first polarization state may be a right circular polarization state and the second polarization state may be a left circular polarization state, or the first polarization state may be a left circular polarization state and the second polarization state may be a right circular polarization state, etc. Light rays 50A and 50B strike display screen 14 and are scattered to filters 46 and 48. Filter 46 passes light rays 50A that are transmitted to one eye, e.g., the left eye, and blocks light rays 50B from reaching the left eye. Filter 48, on the other hand, passes light rays 50B that are transmitted to the other eye, e.g., the right eye, and blocks light rays 50A from reaching the right eye. Thus, the left and right eyes see different images having different polarization states. The images are transmitted through the optic nerves to the brain, which creates a single image having an illusion of depth. It should be noted that in embodiments where activated polarization rotator 126 transmits light in which the light in every other frame has the same polarization state, a viewer using eyewear 16 sees the image in the first frame and the images in every other frame after the first frame in one eye and the image in the second frame and the images in every other frame after the second frame in the other eye. Thus, each eye sees a different image which allows the perception of a three-dimensional image.

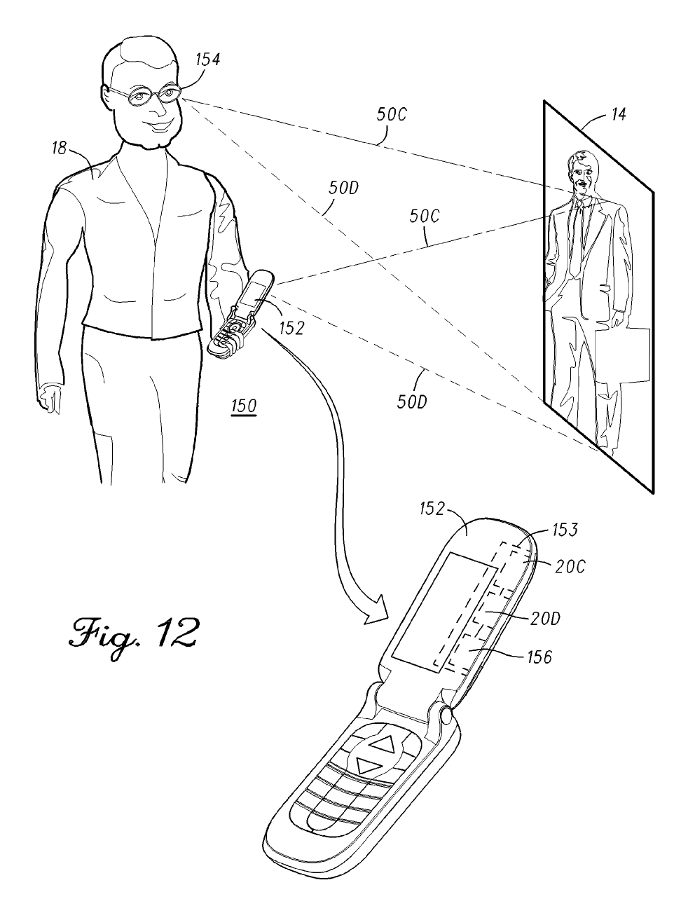

FIG. 12 is a perspective view of a portable image projection system 150 in accordance with another embodiment of the present invention. FIG. 12 illustrates a portable handheld optical projector 152 that is spaced apart from a display screen 14 and that transmits an image to display screen 14. The signal is scattered by display screen 14 and transmitted to a viewer's eyes through eyewear set 154 that is worn by viewer 18. In accordance with one embodiment, portable handheld optical projector 152 comprises a cellular telephone that includes a light emission system 153 comprising a noise generator 156 and two sets of integrated photonics modules 20C and 20D that project optical signals capable of providing privacy for the viewer. Noise generator 156 is also referred to as a noise generation circuit. Alternatively, portable handheld optical projector 152 may be a personal digital assistant (“PDA”) that includes two sets of integrated photonics modules 20C and 20D, a portable personal computer that includes two sets of integrated photonics modules 20C and 20D, a personal video player (“PVP”), a portable gaming device, a HUD, or the like. Portable handheld optical projector 152 is also referred to as a mobile handheld optical projector, a portable handheld optical device, or a mobile handheld optical device.

Portable image projection system 150 includes a light emission system 153 that comprises noise generator 156 and integrated photonics modules 20C and 20D which are similar to integrated photonic module 20 described with reference to FIG. 2. Reference characters “C” and “D” have been appended to reference character 20 to distinguish among integrated photonics modules 20A and 20B. Noise generator 156 is coupled to integrated photonics modules 20C and 20D. Noise generator 156 causes integrated photonics module 20D to generate an optical noise signal that preferably is complementary to the image signal generated by integrated photonics module 20C. For example, the image created by integrated photonics module 20C is the opposite of the image created by integrated photonics module 20D. Thus, the image created by integrated photonics module 20C may be a bright image and the image created by integrated photonics module 20D may be a dark image.

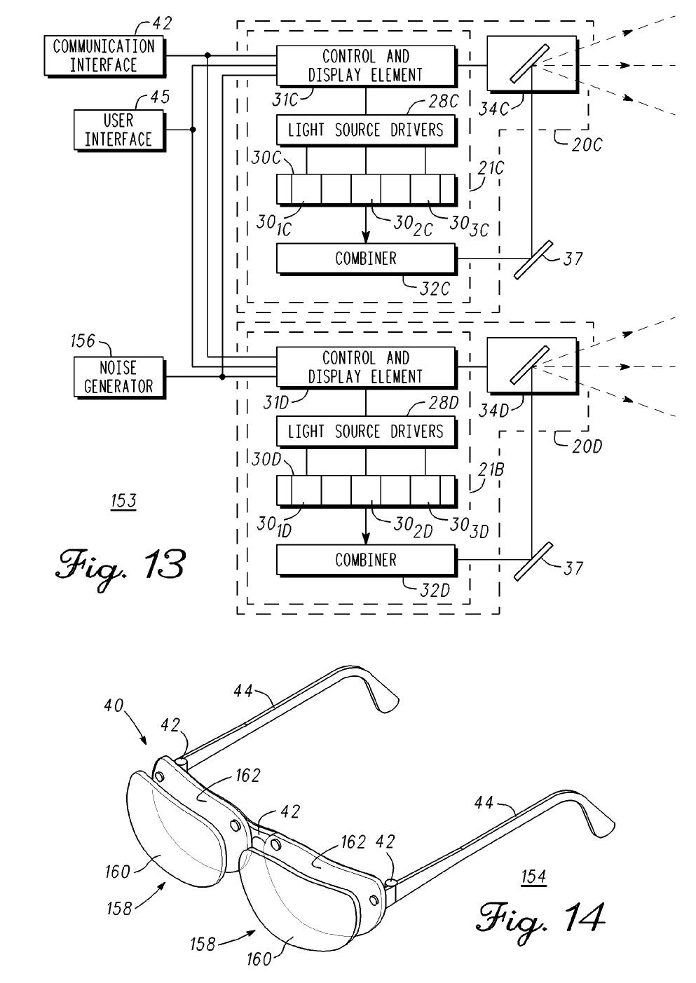

FIG. 13 illustrates a light emission system 153 that includes optical photonics modules 20C and 20D. More particularly, FIG. 13 illustrates optical photonics modules 20C and 20D that comprise a light generating section 21C coupled to a scanning device 34C and a light generating section 21D coupled to a scanning device 34D, respectively. Like, light emission system 19 (shown in FIG. 5), scanning devices 34C and 34D can be comprised of a multi-scanning device scanning system (shown in FIG. 5) or a single-scanning device scanning system (shown in FIG. 6). Noise generator 156 is coupled to integrated photonics modules 20C and 20D. Reference characters “C” and “D” have been appended to reference characters 21, 28, 30, 30₁, 30₂, 30₃, 32, and 32 to distinguish among light generating section 21, light source drivers 28, light sources 30, combiner 32, and scanning devices 34 of optical photonics modules 20A, 20B, 20C, and 20D.

FIG. 14 is an isometric view of eyewear set 154 in accordance with another embodiment of the present invention. Eyewear set 154 comprises frame 40 having bow 42, temples 44, and filters 158 that transmit images to the left and right eyes. Filters 158 are configured to decode polarized light. The polarized light can be linearly polarized light or circularly polarized light. Filters 158 are shown in an exploded view to illustrate that they comprise a quarter-wavelength plate 160 laminated to a polarizer 162. It should be noted that the type of plates laminated to polarizer 162 are not limitations of the present invention. For example, plates 160 can be waveplates, polarizer filters, combinations of polarizers, combinations of waveplates, polarizing optics, or the like. In addition, the polarization transmission characteristics of filters 158 are not limitations of the present invention. Filters 158 may be configured to decode vertically or horizontally polarized light or right or left circularly polarized light. Techniques for coupling plates such as plates 160 to polarizers such as polarizers 162 are known to those skilled in the art.

In operation and referring to FIGS. 12-14, a user activates handheld optical projector 152 so that it projects images onto display screen 14. Activating handheld optical projector 152 enables light emission system 153 to transmit light rays 50C and 50D to display screen 14. Photonics module 20C transmits a light ray 50C that has a linear vertical polarization state and photonics module 20D transmits a light ray 50D that has a linear horizontal polarization state. It should be noted that the type of polarized light is not a limitation of the present invention. For example, the polarization states may be a circular polarization states that are opposite from each other. The images contained in light rays 50C and 50D are slightly different from each other. Light rays 50C and 50D strike display screen 14 and are scattered to filters 158. Filters 158 pass light rays 50C to the right and left eyes, and block light rays 50D thereby preventing them from reaching the right and left eyes. Thus, the viewer wearing eyewear set 154 sees an image on display screen 14, however, individuals not wearing eyewear set 154 see a “flat white” image on display screen 14. Therefore, portable handheld optical projector 152 provides the viewer with privacy while viewing images.

In accordance with another embodiment of the present invention, privacy can be achieved by modifying eyewear 154 so that filters 158 are synchronized to the noise generated by noise generation circuit 156 and to the image or display data contained in the light. Thus, the polarization of the eyewear is a function of time, which creates additional noise thereby increasing the privacy or security between the transmitted light signal and the viewer.

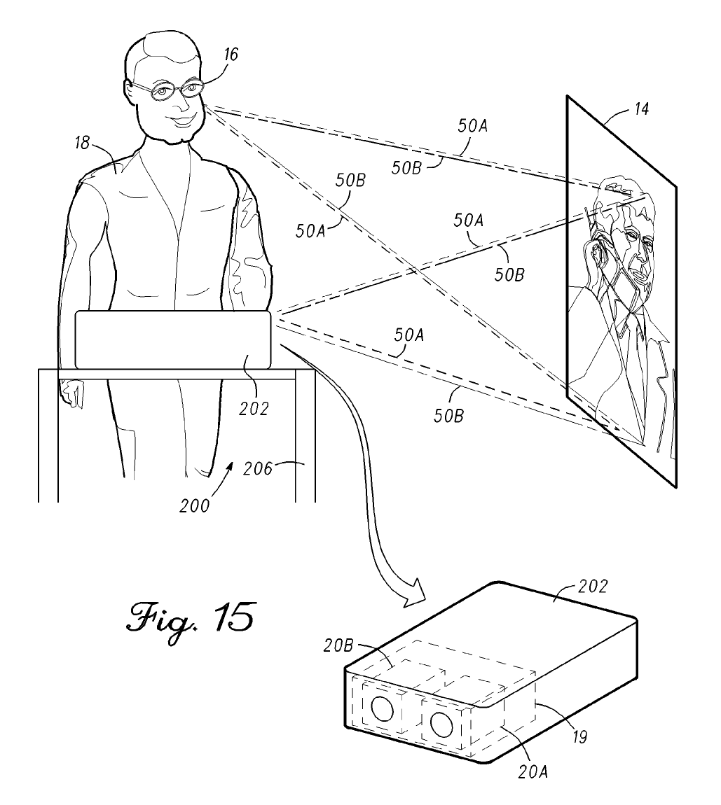

FIG. 15 is a perspective view of a three-dimensional image projection system 200 in accordance with another embodiment of the present invention. FIG. 15 illustrates an optical projector 202 that is spaced apart from a display screen 14 and that transmits an image to display screen 14. The signal is scattered by display screen 14 and transmitted to a viewer's eyes through a set of eyewear 16 worn by viewer 18. In accordance with one embodiment of the present invention, optical projector 202 is a stationary projector that includes light emission system 19 comprising two sets of integrated photonics modules 20A and 20B that project a light or an optical signal capable of producing a three-dimensional image. FIG. 15 illustrates image projection system 200 on a table or stand 206. Integrated photonics modules 20A and 20B are shown by broken lines because they are within optical projector 202. It should be understood that including integrated photonics modules 20A and 20B within optical projector 202 is not a limitation of the present invention. For example, integrated photonics modules 20A and 20B may be embedded within optical projector 202 or connected to optical projector 202 through a wireless protocol, a universal serial bus (“USB”) port, a copper cable, an optical fiber, or the like. The implementation of the optical projector is not a limitation of the present invention. The optical projector may be included in a desk top computer or it may be part of a semi-stationary optical projector. Although three-dimensional image projection system 200 is stationary or part of a semi-stationary optical projector, it operates in a manner similar to, for example, three-dimensional image projection system 10.

Although specific embodiments have been disclosed herein, it is not intended that the invention be limited to the disclosed embodiments. Those skilled in the art will recognize that modifications and variations can be made without departing from the spirit of the invention. For example, the light source may be a monochromatic light source. When the light source is a monochromatic light source, a combiner is absent from the light emission system. It is intended that the invention encompass all such modifications and variations as fall within the scope of the appended claims.

What is claimed is:

1. An image projection system, comprising:
at least one light emission system that emits light in two or more polarization states; and
at least one scanning device that redirects the light emitted by the at least one light emission system.

2. The image projection system of claim 1, further including:
a display screen spaced apart from the at least one scanning device and positioned to receive the light redirected from the at least one scanning device, wherein the light has a first polarization state and a second polarization state, and wherein the display screen scatters a portion of the light from the at least one scanning device; and
eyewear having first and second filters, wherein the first filter substantially passes the light having the first polarization state and substantially blocks the light having the second polarization state and the second filter substantially passes the light having the second polarization state and substantially blocks the light having the first polarization state.

3. The image projection system of claim 2, wherein the display screen maintains the polarization state of the light having the first polarization state and the polarization state of the light having the second polarization state.

4. The image projection system of claim 2, wherein the first polarization state is different from the second polarization state.

5. The image projection system of claim 1, wherein the at least one light emission system comprises:
a first light source that emits light in a first polarization state; and
a second light source that emits light in a second polarization state.

6. The image projection system of claim 5, wherein the first and second light sources emit light of a first color, and wherein the at least one light emission system further comprises:
a third light source that emits light in the first polarization state; and
a fourth light source that emits light in the second polarization state, wherein the third and fourth light sources emit light of a second color that is different from the first color.

7. The image projection system of claim 6, wherein the at least one light emission system comprises:
a fifth light source that emits light in the first polarization state; and
a sixth light source that emits light in the second polarization state, wherein the fifth and sixth light sources emit light of a third color that is different from the first and second colors.

8. The image projection system of claim 1, wherein the at least one light emission system is coupled to one of a cellular phone, a personal digital assistant, a personal computer, a personal video player, a gaming device, or a game controller attached to a gaming console or to the personal computer.

9. The image projection system of claim 1, wherein the image projection system is one of a portable handheld image projection system or a stationary image projection system.

10. An image projection system, comprising:
at least one light emission system that emits light having a first polarization state;
an activated polarization rotator that rotates the light from the first polarization state to a second polarization state; and
at least one scanning device that redirects the light of the first polarization state or the light of the second polarization state.

11. The image projection system of claim 10, wherein the at least one scanning device comprises one of a multi-scanning device scanning system or a single scanning device scanning system.

12. The image projection system of claim 10, further including:
a display screen spaced apart from the at least one scanning device and positioned to receive the light from the at least one scanning device, wherein the display screen scatters a portion of the light from the at least one scanning device; and
eyewear having first and second filters, wherein the first filter substantially passes the light having the first polarization state and substantially blocks the light having the second polarization state and the second filter substantially passes the light having the second polarization state and substantially blocks the light having the first polarization state.

13. The image projection system of claim 12, wherein the display screen maintains the polarization state of the light having the first polarization state and the polarization state of the light having the second polarization state.

14. The image projection system of claim 10, wherein the at least one light emission system comprises:
a first light source that emits light of a first color;
a second light source that emits light of a second color; and
a third light source that emits light of a third color, wherein the first, second, and third colors are different from each other.

15. An image projection system, comprising:
at least one light emission system that emits light having first and second polarization states;
a polarization switch operable in at least first and second switch states, wherein the polarization switch enables transmission of the light from the at least one light emission system; and
at least one scanning device that redirects the light of the first polarization state or the light of the second polarization state.

16. The image projection system of claim 15, wherein the image projection system is one of a portable handheld image projection system or a stationary image projection system.

17. The image projection system of claim 15, wherein the at least one scanning device comprises a plurality of scanning devices.

18. The image projection system of claim 15, wherein the at least one light emission system comprises:
a first light source that emits light of a first color;
a second light source that emits light of a second color; and
a third light source that emits light of a third color, wherein the first, second, and third colors are different.

19. A method for projecting an image using an image projection system, comprising:
projecting a plurality of light signals, wherein a first light signal has a first polarization state and a second light signal has a second polarization state; and
scattering portions of the first and second light signals from the display screen while preserving the first and second polarization states.

20. The method of claim 19, wherein projecting the plurality of light signals includes:
projecting the first light signal and the second light signal by switching between the first light signal having the first polarization state and the second light signal having the second polarization state; and
redirecting the first and second light signals to the display screen.

21. The method of claim 19, wherein projecting the plurality of light signals includes:
rotating the polarization states of the first light signal and the second light signal; and
redirecting the first and second light signals having the rotated polarization states to the display screen.

22. The method of claim 19, wherein the first light signal includes a first light signal component having a first color, a second light signal component having a second color, and a third light signal component having a third color and wherein the first, second, and third light signal components have the first polarization state.

23. A method for displaying an image, comprising:
generating light having a first polarization state; and
scattering the light having the first polarization state, wherein the first polarization state of the scattered light is maintained.

24. The method of claim 23, wherein generating the light comprises rotating the polarization state of the light from the first polarization state to a second polarization state, the light in a first frame having the first polarization state and the light in second frame that is adjacent to the first frame having the second polarization state.

25. The method of claim 23, wherein generating the light further includes generating the light having a second polarization state and switching between transmitting the light having the first polarization state and the light having the second polarization state.
